(19) United States
(12) Patent Application Publication
(10) Pub. No.: US 2009/0211715 A1
(43) Pub. Date: Aug. 27, 2009

(54) Blind display

(76) Inventor: Nkere Udofia, Iselin, NJ (US)

Correspondence Address: AKERMAN SENTERFITT, P.O. BOX 3188, WEST PALM BEACH, FL, 33402-3188, US

(21) Appl. No.: 12/072,690

(22) Filed: Feb. 27, 2008

(51) Int. Cl. E06B 3/30

(52) U.S. Cl. 160/32; 160/405

(57) ABSTRACT

A blind display comprises a frame; a display opening in the frame; a series of display panel supporting members; and a series of display panels supported by the series of display panel supporting members. At least some of the display panels from the series of display panels are adapted to receive a display sample adapted to display a blind sample. At least some of the display panels from the series of display panels are displaceably, e.g. slidably mounted to the series of display panel supporting members and being visible through the display opening. A method for displaying blind samples and a kit are equally disclosed.

### CROSS-REFERENCE TO RELATED APPLICATIONS

No cross-reference.

### FIELD OF THE INVENTION

The present invention relates to a display system. More precisely the present invention relates to a display system for displaying blinds such that different types of blinds could be simultaneously displayed.

### BACKGROUND OF THE INVENTION

Blinds are used in houses and offices to dress windows. They come in various styles, shapes, patterns, textures and colors. Blinds are commonly installed on the wall next to the window to selectively cover the window when privacy is desired, or simply provide the desired fashionable look to the window.

Shopping for blinds requires seeing many different blinds to find the blind the more suited for the specific environment in which they will be installed. Selecting the right type of blind and the appropriate blind color means doing many comparisons among a series of potentially interesting blinds.

In order to really appreciate the distinctive visual rendering of a blind it is recommended to have samples of significant sizes because it is difficult to visualise what will be the effect of the real life installation when relying on a token-size sample. It is also desirable to compare different blind samples together to better see their differences and how they could live together in a common visual arrangement.

Conventional blind displays use a frame on which is affixed a sample of each blind. The frame is then hung on a wall next to other samples of blinds. The amount of wall space needed to display a large collection of blinds is significant and it might not be possible to expose all the blind samples. Otherwise, this might cause some complications when a customer wants to compare different blinds that are not hung next to each other. Firstly, a number of “less-desirable” blind samples are in the line of sight of the customer thus interfering in the customer's appreciation of the “more-desirable” blinds. Secondly, the “more-desirable” blind samples could be removed from the wall to provide an easier comparison but this might easily turn into a sample management nightmare where many blind samples are piled on the floor instead than hung on the wall.

Therefore, a need has be found for an improved blind display over the known arrangements. Similarly, a need has arisen for an improved blind display that would require less wall area and allow to display a significant number of different blind samples. There is also a need for a blind display that would facilitate the comparison between different blind samples.

### SUMMARY OF THE INVENTION

An aspect of the present invention provides an improved blind display over existing blind displays.

Another aspect of the present invention provides a blind display adapted to secure a blind sample on a blind display panel.

One other aspect of the present invention provides a plurality of blind samples adapted to be selectively moved between a superposed position and an adjacent position so that it is possible to hide a blind sample or position a blind sample adjacent to another blind sample to appreciate the difference between blind samples at the same time.

One aspect of the present invention provides a blind display comprising a frame; a display opening in the frame; a series of display panel supporting members; and a series of display panels supported by the series of display panel supporting members, at least some of the display panels from the series of display panels being adapted to receive a display sample adapted to display a blind sample, at least some of the display panels from the series of display panels being displaceably mounted to the series of display panels supporting members and being visible through the display opening.

Another aspect of the present invention provides a blind display wherein the series of display panel supporting members is adapted to selectively position at least two display panels from a superposed position to a juxtaposed position so that only one display panel from the at least two display panels is substantially visible through the display opening, when in the superposed position, and the at least two display panels are substantially visible through the display opening when in the juxtaposed position.

Another aspect of the present invention provides a method of displaying blind samples, the method comprising providing a plurality of blind samples; installing each blind sample from the plurality of blind samples on a display panel; moving at least one display panel between a superposed position and a juxtaposed position with respect to another display panel; mounting a blind sample from the plurality of blind samples to a display module; and securing the display module to one display panel from the plurality of display panels.

One other aspect of the present invention provides a kit of blind samples for use with a blind display, the kit comprising a display module adapted to receive a blind sample so that the blind sample can be seen through the display module; and

a display panel, the display module being sized and designed to be removeably secured to the display panel with other display modules so that a plurality of display modules are capable of being appreciated adjacent to each other in the blind display.

An object of the present invention provides a blind display that is portable, easy to assemble and inexpensive to manufacture.

Embodiments of the present invention each have at least one of the above-mentioned objects and/or aspects, but do not necessarily have all of them.

Additional and/or alternative features, aspects, and advantages of the embodiments of the present invention will become apparent from the following description, the accompanying drawings, and the appended claims.

### BRIEF DESCRIPTION OF THE DRAWINGS

The features of the invention will become more apparent in the following detailed description in which reference is made to the appended drawings wherein:

FIG. 1 is a front isometric view of a blind display in accordance with the present invention;

FIG. 2 is a front elevational view of the blind display;

FIG. 3 is a right side elevational view where a right side portion thereof has been removed to appreciate the internal layout of display panels;

FIG. 4 is an exploded view of a display module adapted to receive in its center a blind sample;

FIG. 5 is a right elevational view of a semi-assembled display module;

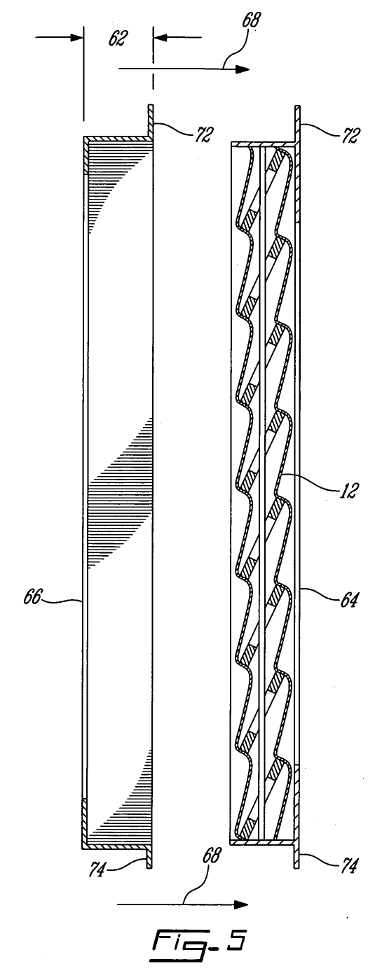

FIG. 6 is a right elevational view of the display module in the process of being assembled to a display panel;

FIG. 7 is a right elevational view of the display module almost assembled to the display panel;

FIG. 8 is a right elevational view of the display module assembled to the display panel; and

FIG. 9 is an isometric view of the blind display depicting an alternate way of assembling a display module to a display panel.

### DETAILED DESCRIPTION OF THE INVENTION

The preferred embodiment illustrated in the Figures is one possible arrangement among other workable variations. These other workable variations are not considered to be enough materially distinctive so that a person skilled in the art of blind displays would not know how to adapt the present invention thereto.

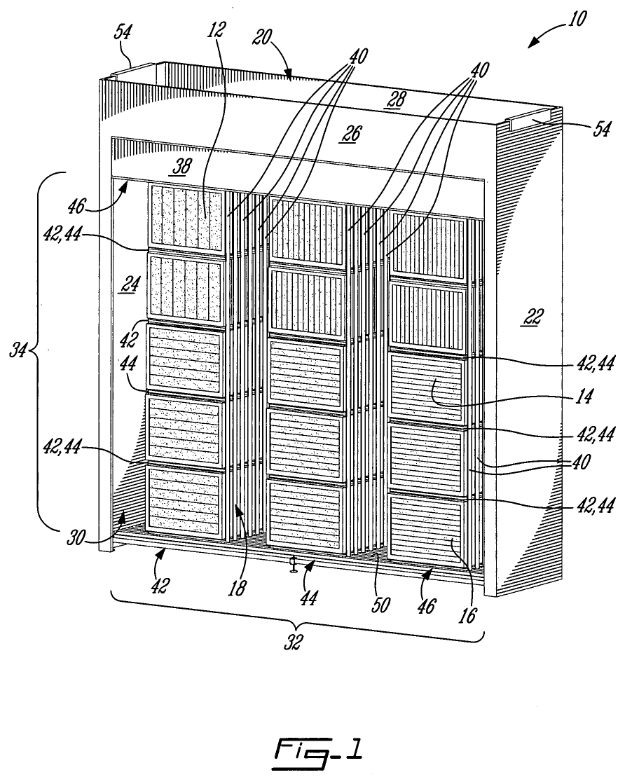

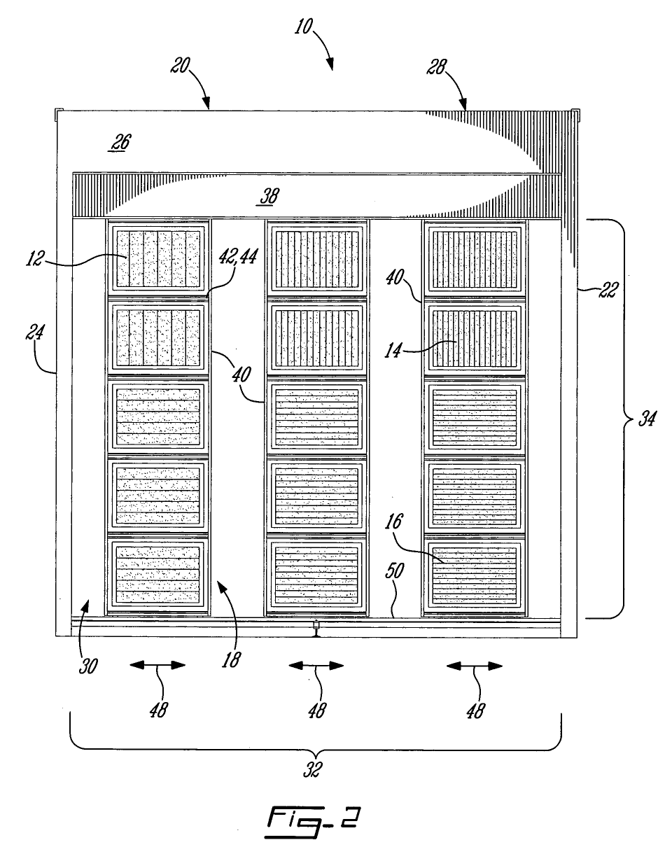

FIGS. 1 and 2 illustrate a blind display 10 for displaying blinds samples 12, 14, 16, 18. The blind display 10 comprises a frame 20 defining a first side portion 22, a second side portion 24, a front portion 26 and a rear portion 28. The illustrated frame 20 could alternatively be built with a different type of structure, like steel tubes or thermoformed plastic structural members, without departing from the scope of the present invention.

The blind display 10 defines a display opening 30 providing a visual access through the front portion 28 to the inside of the blind display 10. The display opening 30 has a significant rectangular size, defined by a width 32 and a height 34, to maximize the number of visible blind samples 12, 14, 16, 18 (among other blind samples not numbered on FIG. 1) displayed by the blind display 10.

Still on FIGS. 1 and 2, the blind display 10 further provides a display wall 38 adapted to receive textual or graphical information in relation with the blind products displayed by the blind display 10. Cardboard clip and pictures can be secured on the display wall 38 with glue, Velcro® or using mechanical means like an upper and lower protruding lips (not shown on FIG. 1) providing a convenient way to easily update the information on the display wall 38.

The illustrated blind display 10 includes a series of display panels 40 disposed, for example, on three rows 42, 44, 46. Each row 42, 44, 46 superposes a series of display panels 40. Each display panel 40 is illustratively a planar support on which can be affixed a number of blind sample, e.g. 12, 14, 16, 18. Blind samples 12, 14, 16, 18 affixed on display panels 40 are preferably oriented like they would be oriented when installed in real life to provide a realistic effect.

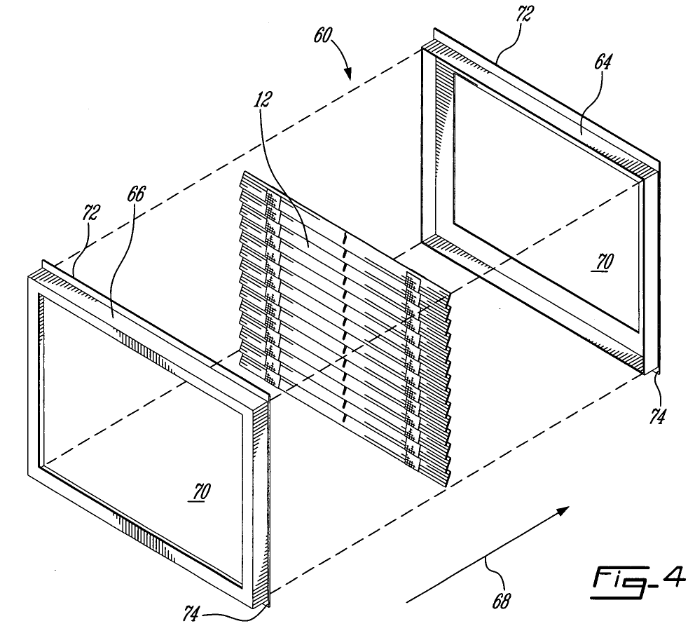

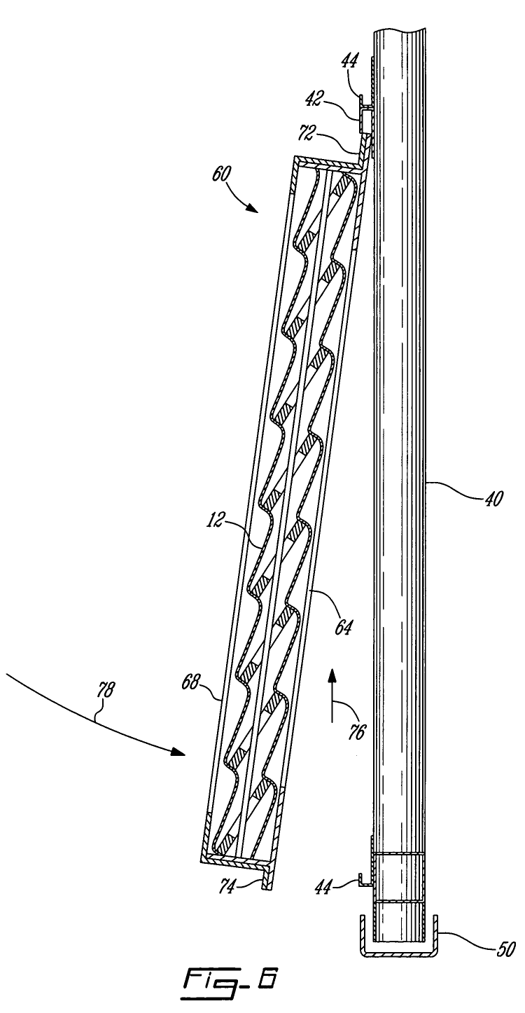

As seen in FIG. 4, each blind sample 12, 14, 16, 18 is preferably individually framed with a display module 60 in order to easily secure blind samples 12, 14, 16, 18 on the display panel 40. Although it is more convenient to manipulate blind samples 12, 14, 16, 18 when they are framed with their respective display module 60 it is not mandatory to use display modules 60. Each display panel 40 is provided with a series of module connectors 42, 44 facilitating the installation of the blind samples 12, 14, 16, 18 to their respective display panel 40. The display module 60 and the interaction with the modules connectors 42, 44 (see FIG. 6) will be described in further details later in the specification.

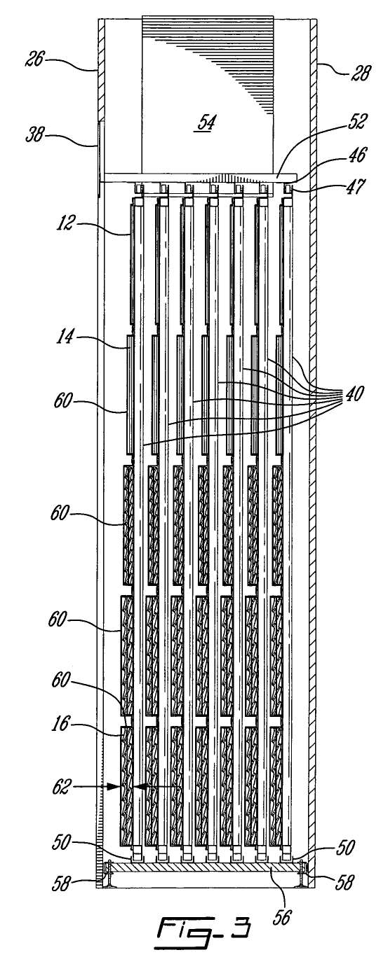

Each display panel 40 is held into the blind display 10 with a series of display panels supporting members 46. The series of display panels supporting members 46 are not visible on FIGS. 1 and 2 although their positions are indicated by arrow 46, as seen in FIG. 3. Each display panel 40 is connected to one display panel supporting member 46 from the series of display panels supporting members 46. Each display panel 40 in a series of superposed display panel 40 is connected to a distinct display panel supporting member 46. The connection between the display panel 40 and its related display panel supporting member 46 allows to slide the display panel 40 along the display panel supporting member 46 according to arrow 48 to selectively see the display panels 40 that are not already visible.

The display-panel 40 is preferably attached from its upper portion to be suspended to its related display panels supporting member 46 via a set of rollers 47 (not visible on FIGS. 1 and 2 but shown in FIG. 3). One suitable type of display panel supporting member 46 might be a rail member, as exemplified in FIG. 3. The combination of the set of rollers 47 with a rail member would significantly minimize the friction between the display panel 40 and its display panel supporting member 46 thus facilitating movements along arrow 48 of the display panel 40 along the rail. An alternate type of display panel supporting member 46 could be a grooved member 50 at the bottom of the blind display 10, which could accommodate a sliding of the bottom portion of the display panel 40. Although it is a workable mechanism it is likely to be more difficult to move the display panel 40 along arrow 48 with the weight of the display panel 40 held by the grooved member 50 than the previously discussed rail-roller mechanism.

In the present embodiment the groove member 50 is primarily intended to guide the bottom portion of each display panel 40 as opposed to bear the weight of the display panel 40. It ensures that two superposed display panels 40 will not interfere with each other and reduces the risk of damaging blind samples 12, 14, 16, 18.

As best seen on FIG. 2, lateral movements of the three series of superposed display panels 40 could provide enough room to completely see five series of superposed display panels 40 over the width of the display opening 30. Since each display panel 40 from the series of superposed display panels 40 is connected to a different display panel supporting member 46 it is possible to laterally move a specific display panel 40 laterally out of the series of display panels 40 to juxtapose two display panels 40 that were superposed and compare the blind samples 12, 14, 16, 18 affixed thereto. It is therefore possible with the blind display 10 to juxtapose a significant number of display panels 40 to compare the blind samples 12, 14, 16, 18 contained therein.

It is also easy to change the display panel 40 to put a new display panel 40 with different blind samples 12, 14, 16, 18 inside the blind display 10. This is a quick and convenient way to change the blind samples 12, 14, 16, 18 available in the blind display 10. Otherwise, as it will be exposed in more details later in the specification, it is always possible to change the blind samples 12, 14, 16, 18 from a display panel 40 while the display panel 40 remains in the blind display 10.

Referring now to FIG. 3 one can appreciate the series of display panels 40 seen from the side with their associated blind samples 12, 14, 16, 18. Each display panel 40 is hung by its upper portion to its related display panel supporting members 46 via its set of rollers 48. The series of display panel supporting members 46 are secured to a supporting member frame 52 and the supporting member frame 52 is connected to a frame hook 54 on each side (only one is visible on FIG. 3 given it is seen from one side, both ones are visible on FIG. 1). In turn, the frame hooks 54 rest on the side portions 22, 24 in an easy to disassemble fashion thus supporting the supporting member frame 52.

A retaining base 56 holds a series of grooved members 50 at constant intervals. The retaining base 56 is supported by a plurality of height adjustment mechanisms 58 to maintain the retaining base 56 at the desired distance from the bottom portion of the display panels 46. This adjustment is desirable to prevent the lower portion of the display panels 40 from touching the bottom of the grooved members 50 (as best seen on magnified FIG. 6) and thus reduce friction while keeping the lower portions of the display panels 40 within their respective groove member 50 to guide the display panels 40.

It can also be appreciated from FIG. 3 that the display modules 60 have different thicknesses 62 to accommodate blind samples 12, 14, 16, 18 of various thicknesses.

An exploded view of a display module 60 can be seen on FIG. 4. A module base frame 64 and a module covering frame 66 are separable to insert a blind sample 12 therebetween. Once the blind sample 12 is properly installed in the base frame 64, the covering frame 66 is mated 68 over the base frame 64 to secure the blind sample 12 inside the volume defined inside the display module 60. Openings 70 are provided in the display module 60 to see the blind sample 12 from both sides (assuming there is a corresponding opening in the display panel 40 and the display panel 40 is installed in the blind display 10 or that there is a display opening 30 on the rear portion of the blind display 10 to appreciate the reverse side of a blind sample).

An upper module connector 72 is disposed on the upper portion of each of the base frame 64 and the covering frame 66. Similarly, a lower module connector 74 is disposed on the lower portion of each of the base frame 64 and the covering frame 66. Once the base frame 64 and the covering frame 66 are assembled the upper module connectors 72 and the lower module connectors 74 of both the base frame 64 and the covering frame 66 are temporarily unified (see FIG. 6).

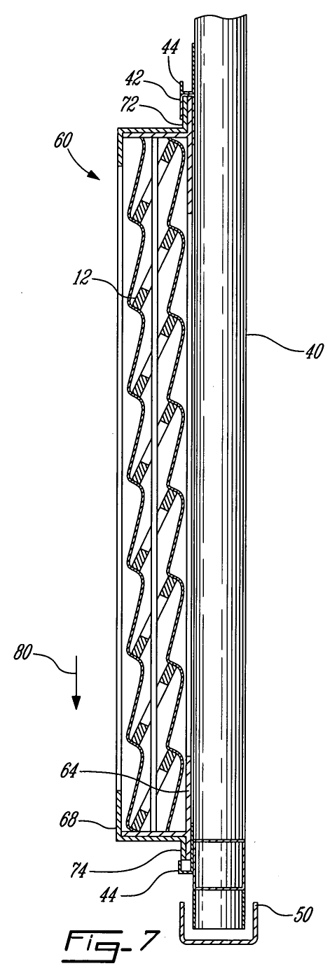

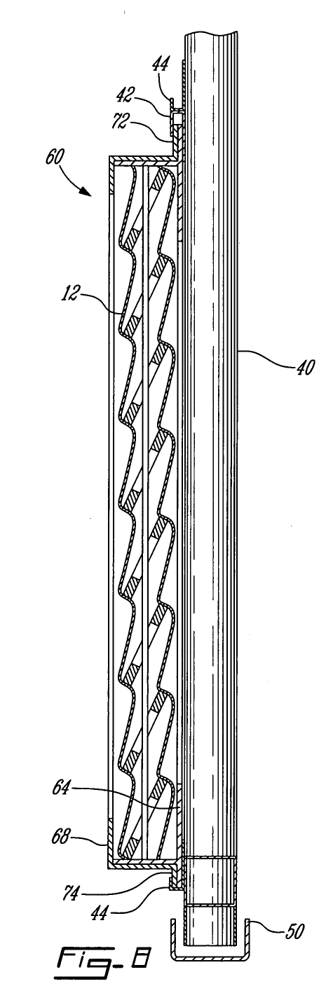

As best seen on FIGS. 6 through 8, the upper module connector 72 is inserted as per arrow 76 into corresponding upper module connector 42 of the display panel 40 and then the display module 60 is pivoted (see arrow 78) until the display module 60 becomes parallel with the surface of the display panel 40. After, the display module 60 is translated down along arrow 80 on FIG. 7 and reaches its final position when the lower module connector 74 rests deep inside the corresponding lower module connector 44 of the display panel 40 (see FIG. 8). It has to be noted that this type of connection is possible because the length of the upper module connector 72 is longer than the height of the lower module connector 74.

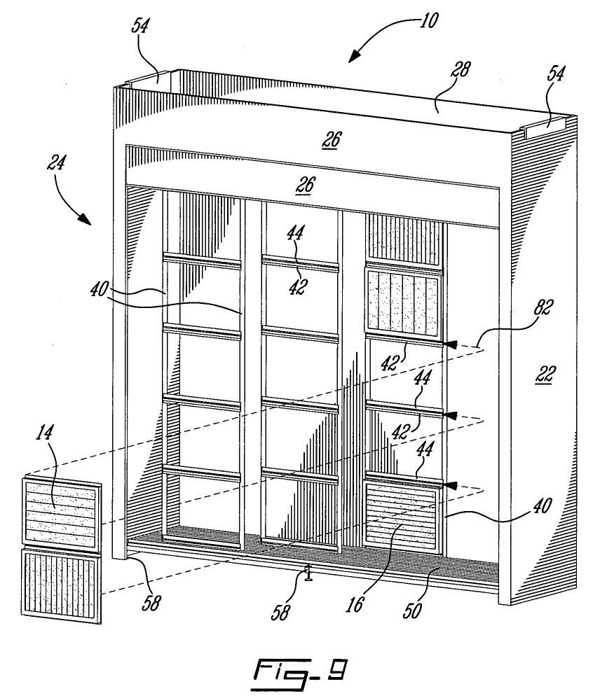

FIG. 9 illustrates an alternate display module 60 assembly with a display panel 40. Instead of inserting the upper module connector 72 inside the corresponding display panel 40 upper module connector 42 in a front-loading manner as in FIGS. 6 to 8, the display module 60 of FIG. 9 is simply slid inside the corresponding connectors 42, 44 of the display panel 40 laterally from one side thereof.

Although the invention has been described with reference to certain specific embodiments, various modifications and improvements thereof will be apparent to those skilled in the art without departing from the spirit and scope of the invention as outlined in the claims appended hereto. The entire disclosures of all references recited above are incorporated herein by reference.

What is claimed is:

1. A blind display comprising:
a frame;
a display opening in the frame;
a series of display panel supporting members; and
a series of display panels supported by the series of display panel supporting members, at least some of the display panels from the series of display panels being adapted to receive a display sample adapted to display a blind sample, at least some of the display panels from the series of display panels being displaceably mounted to the series of display panels supporting members and being visible through the display opening.

2. The blind display of claim 1, wherein the series of display panel supporting members is adapted to selectively position at least two display panels between a superposed position and a juxtaposed position so that only one display panel from the at least two display panels is substantially visible through the display opening when in the superposed position, and the at least two display panels are substantially visible through the display opening when in the juxtaposed position.

3. The blind display of claim 1, wherein at least one display panel supporting members from the series of display panel supporting members is a rail adapted to hang and to allow a sliding movement along the rail of at least one of the supported display panels.

4. The blind display of claim 3, wherein the display panels are provided with rollers adapted to displace along the rail.

5. The blind display of claim 1, wherein the series of display panel supporting members are adapted to suspend the display panels, the blind display further comprising a series of bottom guide members supported by the frame, the series of bottom guide members being adapted to guide lower portions of the display panels.

6. The blind display of claim 5, wherein the series of bottom guide members are secured to a retaining base.

7. The blind display of claim 6, wherein the retaining base is adjustable with respect to the lower portion of the display panels.

8. The blind display of claim 1, wherein the frame comprises a first side portion, a second side portion and a connecting portion interconnecting the first side portion and the second side portion so that the blind display is transportable as a unit.

9. The blind display of claim 1, comprising a display wall adapted to display information next to the display opening.

10. The blind display of claim 1, wherein at least some of the display panels from the series of display panels are adapted to receive a plurality of display modules.

11. The blind display of claim 10, wherein each display module from the plurality of display modules comprises a module base frame and a module covering frame, the module base frame and the module covering frame defining a volume adapted to receive a blind sample.

12. The blind display of claim 11, wherein at least one of the module base frame and the module covering frame comprises an upper module connector and a lower module connector, these connectors being adapted to cooperate with corresponding receiving connectors disposed on at least some of the display panels to secure the display module thereto.

13. The blind display of claim 12, wherein the display modules are adapted to be removeably secured to the display panel such that the display modules are interchangeable.

14. The blind display of claim 10, wherein the display modules have a width and a height, the display opening having a width that is about a multiple of the display modules width and a height that is about a multiple of the display modules height.

15. The blind display of claim 10, wherein the display modules have a thickness, the thickness being adjustable to accommodate blind samples of various thicknesses.

16. A method of displaying blind samples, the method comprising:
providing a plurality of blind samples;
installing each blind sample from the plurality of blind samples on a display panel; and
moving at least one display panel between a superposed position and a juxtaposed position with respect to another display panel.

17. The method of claim 16, comprising:
mounting a blind sample from the plurality of blind samples to a display module; and
securing the display module to one display panel from the plurality of display panels.

18. The method of claim 17, comprising replacing the display module form the one display panel with another display module.

19. A kit of blind samples for use with a blind display, the kit comprising:
a display module adapted to receive a blind sample so that the blind sample can be seen through the display module; and
a display panel, the display module being sized and designed to be removeably secured to the display panel with other display modules so that a plurality of display modules are capable of being appreciated adjacent to each other in the blind display.
